(19) United States
(12) Patent Application Publication
(10) Pub. No.: US 2025/0081091 A1
(43) Pub. Date: Mar. 6, 2025

(54) Preemption of Downlink Data for Uplink Data or Coexistence Events

(71) Applicant: Apple Inc., Cupertino, CA (US)

(72) Inventors: Mohamed Abouelseoud, Burlingame, CA (US); Akira Yamanaka, Sunnyvale, CA (US); Wook Bong Lee, San Jose, CA (US); Oren Shani, Cupertino, CA (US); Zhou Lan, San Jose, CA (US); Qi Wang, Sunnyvale, CA (US); Anuj Batra, Redwood City, CA (US); Jarkko L. Kneckt, Los Gatos, CA (US); Yong Liu, Campbell, CA (US); Su Khiong Yong, Palo Alto, CA (US)

(21) Appl. No.: 18/750,400

(22) Filed: Jun. 21, 2024

Related U.S. Application Data
(60) Provisional application No. 63/579,943, filed on Aug. 31, 2023.

(51) Int. Cl. H04W 48/16; H04L 5/00; H04W 72/23; H04W 76/15

(52) U.S. Cl. CPC H04W 48/16; H04L 5/0048; H04W 72/23; H04W 76/15

(57) ABSTRACT

This disclosure relates to methods for transmission preemption in a wireless local area network. A downlink transmission may be performed by an access point device on a first wireless link. Signaling requesting or indicating preemption of the downlink transmission may be provided from a non-access point device to the access point device on a second wireless link. The downlink transmission may be preempted based at least in part on the signaling requesting or indicating preemption of the downlink transmission.

### PRIORITY INFORMATION

This application claims priority to U.S. provisional patent application Ser. No. 63/579,943, entitled “Preemption of Downlink Data for Uplink Data or Coexistence Events,” filed Aug. 31, 2023, which is hereby incorporated by reference in its entirety as though fully and completely set forth herein.

### TECHNICAL FIELD

The present application relates to wireless communication, including techniques and devices for preempting downlink data for uplink data or coexistence events in a wireless local area network architecture.

### BACKGROUND

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs) may take the form of smart phones or tablets that a user typically carries. One aspect of wireless communication that may commonly be performed by mobile devices may include wireless networking, for example over a wireless local area network (WLAN), which may include devices that operate according to one or more communication standards in the IEEE 802.11 family of standards. In a wireless local area network, it may be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for devices to preempt downlink data for uplink data or coexistence events in a wireless local area network architecture.

A wireless device may include one or more antennas, one or more radios operably coupled to the one or more antennas, and a processor operably coupled to the one or more radios. The wireless device may be configured to establish a connection with an access point through a wireless local area network (WLAN) over one or multiple wireless links, or may be an access point configured to establish a connection with one or more other wireless devices through a WLAN over one or multiple wireless links. The wireless device may operate in each of the multiple wireless links using a respective radio of the one or more radios.

According to the techniques described herein, a wireless device may determine to preempt a downlink data transmission from an access point on one link, and may provide preemption signaling to the access point on another link in order to facilitate the preemption. The preemption signaling may include an implicit or explicit preemption indication to indicate that the wireless device has stopped receiving the downlink data transmission, or possibly a preemption request to indicate that the wireless device is requesting that the downlink data transmission be preempted.

Once the downlink data transmission has been preempted, the wireless device may proceed with one or more operations that precipitated the preemption of the downlink data transmission. This could include performing an uplink data transmission (e.g., for uplink data that has low latency requirements or is otherwise higher priority than the downlink data that was being transmitted) or attending a coexistence event, among various possibilities.

Since the access point may be aware of the preemption of the downlink data transmission, it may be possible that the wireless device is not punished with a reduced downlink transmission rate because of any missed data after the wireless device has stopped receiving the downlink data transmission. Thus, at least according to some embodiments, the techniques described herein may be used to support better servicing of low latency uplink traffic with relatively low impact on other aspects of wireless device operation and network use efficiency. Note that in some embodiments, the techniques described herein can apply to uplink transmission as well.

The techniques described herein may be implemented in and/or used with a number of different types of devices, including but not limited to cellular phones, tablet computers, accessory and/or wearable computing devices, portable media players, base stations and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for preempting downlink data transmission for uplink data or coexistence events in a wireless local area network, according to some embodiments;

FIG. 6 illustrates example aspects of a possible scenario in which a wireless device can preempt a downlink transmission from an access point on one link to perform a low latency uplink transmission on another link without directly informing the access point, according to some embodiments;

FIG. 7 illustrates example aspects of a scenario in which preemption signaling can be used to implement uplink preemption of downlink data, according to some embodiments;

FIGS. 8-9 illustrate example aspects of possible scenarios in which preemption signaling can be used to preempt downlink data for coexistence operation, according to some embodiments;

FIGS. 10-11 illustrate example aspects of further possible scenarios in which preemption signaling can be used for uplink preemption of downlink data, according to some embodiments;

FIG. 12 illustrates example aspects of an access point centric variation of the scenarios of FIGS. 10-11, according to some embodiments;

FIG. 13 illustrates example aspects of a further possible scenario in which preemption signaling can be used to preempt downlink data for coexistence operation, according to some embodiments;

FIGS. 14-15 illustrate example aspects of more possible scenarios in which preemption signaling can be used to preempt downlink data for uplink data, according to some embodiments;

FIG. 16 illustrates an example of a possible set of A-Control subfields that could be used for preemption indication, according to some embodiments;

FIG. 17 illustrates an example of a possible preemption indication frame, including possible preemption indication information subfields, according to some embodiments;

FIG. 18 illustrates an example of a multi-station block acknowledgement frame that can be used to provide a preemption indication, according to some embodiments;

FIG. 19 illustrates an example of a possible preemption request frame, including possible preemption request information subfields, according to some embodiments; and

FIG. 20 illustrates an example of a possible preemption response frame, including possible preemption response information subfields, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices, laptops, wearable devices (e.g., smart watch, smart glasses), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” (also called “eNB” or “gNB”) has the full breadth of its ordinary meaning, and at least includes a wireless communication station installed at a fixed location and used to communicate as part of a wireless communication system. The term “access point” (or “AP”) is typically associated with Wi-Fi based communications and is used similarly.

Processing Element (or Processor)—refers to various elements or combinations of elements that are capable of performing a function in a device, e.g., in a communication device or in a network infrastructure device. Processors may include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

Automatically—refers to an action or operation performed by a computer system (e.g., software executed by the computer system) or device (e.g., circuitry, programmable hard ware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

IEEE 802.11—refers to technology based on IEEE 802.11 wireless standards such as 802.11a, 802.11.b, 802.11g, 802.11n, 802.11-2012, 802.11ac, 802.11ad, 802.11ax, 802.1lay, 802.11be, and/or other IEEE 802.11 standards. IEEE 802.11 technology may also be referred to as “Wi-Fi” or “wireless local area network (WLAN)” technology.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

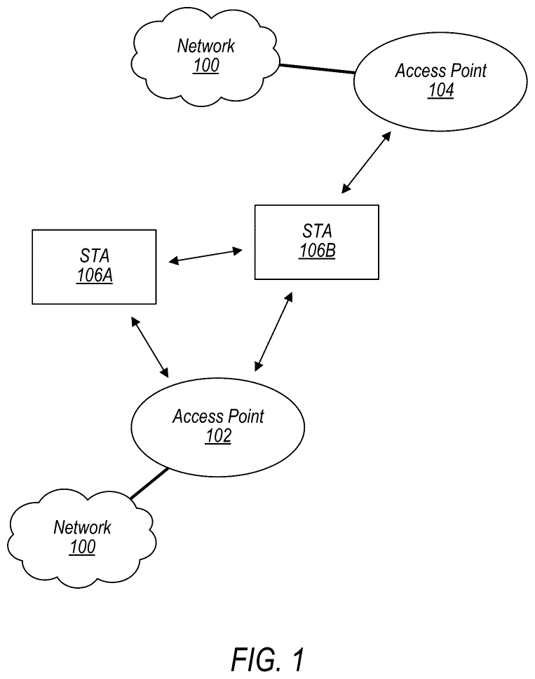

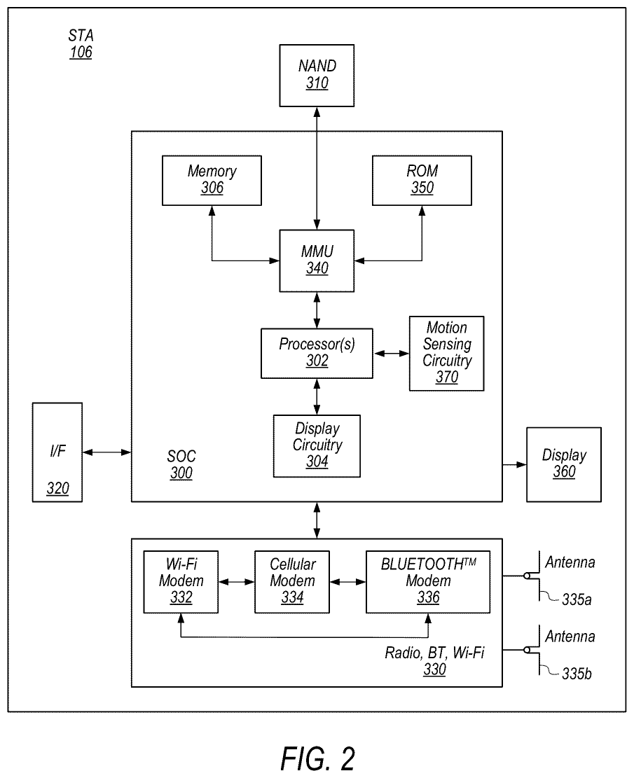

### FIGS. 1-2—Wireless Communication System

FIG. 1 illustrates an example of a wireless communication system. It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown, the example wireless communication system includes an access point (AP) 102, which communicates over a transmission medium with one or more wireless devices 106A, 106B, etc. Wireless devices 106A and 106B may be user devices, such as stations (STAs), non-AP STAs, or WLAN devices.

The STA 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The STA 106 may include a processor (processing element) that is configured to execute program instructions stored in memory. The STA 106 may perform any of the method embodiments described herein by executing such stored instructions. Alternatively, or in addition, the STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The AP 102 may be a stand-alone AP or an enterprise AP, and may include hardware that enables wireless communication with the STA devices 106A and 106B. The AP 102 may also be equipped to communicate with a network 100 (e.g., a WLAN, an enterprise network, and/or another communication network connected to the Internet, among various possibilities). Thus, the AP 102 may facilitate communication among the STA devices 106 and/or between the STA devices 106 and the network 100. In other implementations, AP 102 can be configured to provide communications over one or more wireless technologies, such as any, any combination of, or all of 802.11 a, b, g, n, ac, ad, ax, ay, be and/or other 802.11 versions, or a cellular protocol, such as 5G or LTE, including in an unlicensed band (e.g., LAA, NR-U).

The communication area (or coverage area) of the AP 102 may be referred to as a basic service area (BSA) or cell. The AP 102 and the STAs 106 may be configured to communicate over the transmission medium using any of various radio access technologies (RATs) or wireless communication technologies, such as Wi-Fi, LTE, LTE-Advanced (LTE-A), 5G NR, ultra-wideband (UWB), etc.

AP 102 and other similar access points (not shown) operating according to one or more wireless communication technologies may thus be provided as a network, which may provide continuous or nearly continuous overlapping service to STA devices 106A-B and similar devices over a geographic area, e.g., via one or more communication technologies. A STA may roam from one AP to another directly, or may transition between APs and cellular network cells.

Note that at least in some instances a STA device 106 may be capable of communicating using any of multiple wireless communication technologies. For example, a STA device 106 might be configured to communicate using one or more of Wi-Fi, LTE, LTE-A, 5G NR, Bluetooth, UWB, one or more satellite systems, etc. Other combinations of wireless communication technologies (including more than two wireless communication technologies) are also possible. Likewise, in some instances a STA device 106 may be configured to communicate using only a single wireless communication technology.

As shown, the example wireless communication system also can include an access point (AP) 104, which communicates over a transmission medium with the wireless device 106B. The AP 104 also provides communicative connectivity to the network 100. Thus, according to some embodiments, wireless devices may be able to connect to either or both of the AP 102 (or a cellular base station) and the access point 104 (or another access point) to access the network 100. For example, a STA may roam from AP 102 to AP 104 based on one or more factors, such as coverage, interference, and capabilities. Note that it may also be possible for the AP 104 to provide access to a different network (e.g., an enterprise Wi-Fi network, a home Wi-Fi network, etc.) than the network to which the AP 102 provides access.

The STAs 106A and 106B may include handheld devices such as smart phones or tablets, wearable devices such as smart watches or smart glasses, and/or may include any of various types of devices with cellular communications capability. For example, one or more of the STAs 106A and/or 106B may be a wireless device intended for stationary or nomadic deployment such as an appliance, measurement device, control device, etc.

The STA 106B may also be configured to communicate with the STA 106A. For example, the STA 106A and STA 106B may be capable of performing direct device-to-device (D2D) communication. In some embodiments, such direct communication between UEs may also or alternatively be referred to as peer-to-peer (P2P) communication. The direct communication may be supported by the AP 102 (e.g., the AP 102 may facilitate discovery, among various possible forms of assistance), or may be performed in a manner unsupported by the AP 102. Such P2P communication may be performed using 3GPP-based D2D communication techniques, Wi-Fi-based P2P communication techniques, UWB, BT, and/or any of various other direct communication techniques, according to various embodiments.

The STA 106 may include one or more devices or integrated circuits for facilitating wireless communication, potentially including a Wi-Fi modem, cellular modem and/or one or more other wireless modems. The wireless modem(s) may include one or more processors (processor elements) and various hardware components as described herein. The STA 106 may perform any of (or any portion of) the method embodiments described herein by executing instructions on one or more programmable processors. For example, the STA 106 may be configured to perform techniques for preempting downlink data for uplink data or coexistence events in a wireless communication system, such as according to the various embodiments described herein. Alternatively, or in addition, the one or more processors may be one or more programmable hardware elements such as an FPGA (field-programmable gate array), application-specific integrated circuit (ASIC), or other circuitry, that is configured to perform any of the method embodiments described herein, or any portion of any of the method embodiments described herein. The wireless modem(s) described herein may be used in a STA device as defined herein, a wireless device as defined herein, or a communication device as defined herein. The wireless modem described herein may also be used in an AP, a base station, a pico cell, a femto cell, or other similar network side device.

The STA 106 may include one or more antennas for communicating using two or more wireless communication protocols or radio access technologies. In some embodiments, the STA 106 can be configured to communicate using a single shared radio. The shared radio may couple to a single antenna, or may couple to multiple antennas (e.g., for MIMO) for performing wireless communications. Alternatively, the STA 106 may include two or more radios, each of which may be configured to communicate via a respective wireless link. Other configurations are also possible.

### FIG. 2—Example Block Diagram of a STA Device

FIG. 2 illustrates one possible block diagram of a STA device, such as STA device 106. In some instances, the STA 106 may alternatively be referred to as a UE 106. STA 106 also may be referred to as a non-AP STA 106. As shown, the STA 106 may include a system on chip (SOC) 300, which may include one or more portions configured for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may include processor(s) 302, which may execute program instructions for the STA 106, and display circuitry 304 which may perform graphics processing and provide display signals to the display 360. The SOC 300 may also include motion sensing circuitry 370 which may detect motion of the STA 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 300 may be coupled to various other circuits of the STA 106. For example, the STA 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, 5G NR, Bluetooth, Wi-Fi, NFC, GPS, UWB, etc.).

The STA device 106 may include at least one antenna, and in some embodiments multiple antennas 335a and 335b, for performing wireless communication with base stations and/or other devices. For example, the STA device 106 may use antennas 335a and 335b to perform the wireless communication. As noted above, the STA device 106 may in some embodiments be configured to communicate wirelessly using a plurality of wireless communication standards or radio access technologies (RATs).

The wireless communication circuitry 330 may include a Wi-Fi modem 332, a cellular modem 334, and a Bluetooth modem 336. The Wi-Fi modem 332 is for enabling the STA 106 to perform Wi-Fi or other WLAN communications, e.g., on an 802.11 network. The Bluetooth modem 336 is for enabling the STA 106 to perform Bluetooth communications. The cellular modem 334 may be a cellular modem capable of performing cellular communication according to one or more cellular communication technologies, e.g., in accordance with one or more 3GPP specifications.

As described herein, STA 106 may include hardware and software components for implementing embodiments of this disclosure. For example, one or more components of the wireless communication circuitry 330 (e.g., Wi-Fi modem 332, cellular modem 334, BT modem 336) of the STA 106 may be configured to implement part or all of the methods for preempting downlink data for uplink data or coexistence events described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

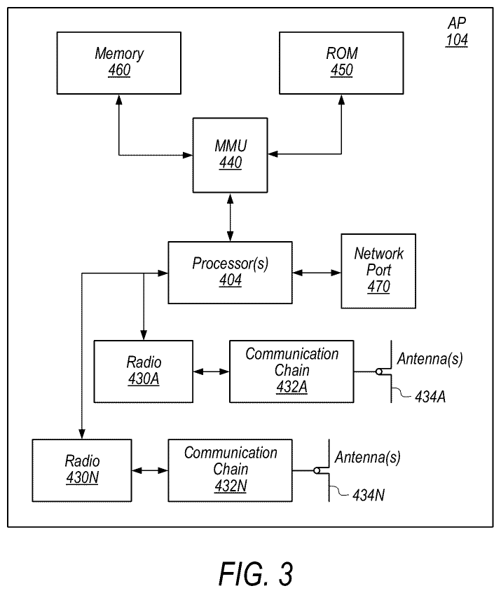

### FIG. 3

### Block Diagram of an Access Point

FIG. 3 illustrates an example block diagram of an access point (AP) 104, according to some embodiments. In some instances (e.g., in an 802.11 communication context), the AP 104 may also be referred to as a station (STA), and possibly more particularly as an AP STA. It is noted that the AP of FIG. 3 is merely one example of a possible access point. As shown, AP 104 may include processor(s) 404 which may execute program instructions for the AP 104. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The AP 104 may include at least one network port 470. The network port 470 may be configured to couple to a telephone network and provide a plurality of devices, such as STA devices 106, with access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The AP 104 may include one or more radios 430A-430N, each of which may be coupled to a respective communication chain and at least one antenna 434, and possibly multiple antennas. The antenna(s) 434 may be configured to operate as a wireless transceiver and may be further configured to communicate with UE devices 106/107 via radio 430. The antenna(s) 434A-N communicate with their respective radios 430A-N via communication chains 432A-N. Communication chains 432 may be receive chains, transmit chains, or both. The radios 430A-N may be configured to communicate in accordance with various wireless communication standards, including, but not limited to, LTE, LTE-A, 5G NR, UWB, Wi-Fi, BT, etc. The AP 104 may be configured to operate on multiple wireless links using the one or more radios 430A-N, wherein each radio is used to operate on a respective wireless link.

The AP 104 may be configured to communicate wirelessly using multiple wireless communication standards. In some instances, the AP 104 may include multiple radios, which may enable the network entity to communicate according to multiple wireless communication technologies. For example, as one possibility, the AP 104 may include a 4G or 5G radio for performing communication according to a 3GPP wireless communication technology as well as a Wi-Fi radio for performing communication according to Wi-Fi. In such a case, the AP 104 may be capable of operating as both a cellular base station and a Wi-Fi access point. As another possibility, the AP 104 may include a multi-mode radio which is capable of performing communications according to any of multiple wireless communication technologies (e.g., 5G NR and Wi-Fi, 5G NR and LTE, etc.). As still another possibility, the AP 104 may be configured to act exclusively as a Wi-Fi access point, e.g., without cellular communication capability.

As described further herein, the AP 104 may include hardware and software components for implementing or supporting implementation of features described herein, such as preempting downlink data for uplink data or coexistence events, among other possible features. The processor 404 of the AP 104 may be configured to implement or support implementation of part or all of the methods described herein, e.g., by executing program instructions stored on a memory medium (e.g., a non-transitory computer-readable memory medium) to operate multiple wireless links using multiple respective radios. Alternatively, the processor 404 may be configured as a programmable hardware element, such as an FPGA (Field Programmable Gate Array), or ASIC (Application Specific Integrated Circuit), or a combination thereof. Alternatively (or in addition) the processor 404 of the AP 104, in conjunction with one or more of the other components 430, 432, 434, 440, 450, 460, 470 may be configured to implement or support implementation of part or all of the features described herein.

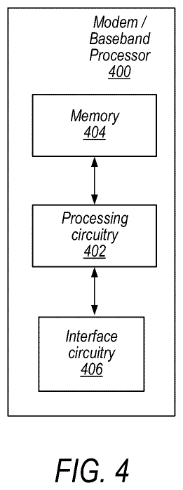

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as performing preemption of downlink data for uplink data or coexistence events, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

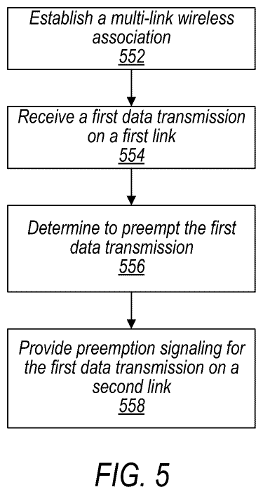

### FIG. 5—Flowchart

FIG. 5 is a flowchart diagram illustrating a method for supporting preemption of downlink data for uplink data or coexistence events in a WLAN, according to some embodiments. In various embodiments, some of the elements of the methods shown may be performed concurrently, in a different order than shown, may be substituted for by other method elements, or may be omitted. Additional method elements may also be performed as desired.

Aspects of the method of FIG. 5 may be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 may be used in any suitable wireless communication system, as desired. As shown, the methods may operate as follows.

At least two wireless devices may establish a wireless association (552). The wireless association may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

The wireless association may include multiple links. For example, an AP wireless device may be an AP multi-link device (MLD), and a non-AP wireless device may be a non-AP MLD, with links established on two or more of a 2.4 GHz band, a 5 GHz band, or a 6 GHz band. Thus, the AP MLD and the non-AP MLD may be able to communicate on at least a first link and a second link. Note that such multi-link operation may be supported by an enhanced multi-link single radio (eMLSR) capable wireless device, or by a simultaneous transmit and receive (STR) capable wireless device, among various possibilities. In the case of an eMLSR device, it may be possible that the non-AP wireless device includes a “main” radio and an “auxiliary” radio, where the auxiliary radio is capable of limited wireless reception and possibly transmission operations (e.g., up to a certain modulation and coding scheme (MCS) and operating bandwidth, such as MCS-4 and a 20 MHz bandwidth, as one possibility), and can thus be used for channel sensing and possibly performing certain signaling transmissions, while the main radio is capable of a broader range of wireless reception and transmission operations, potentially including data transmission and reception. In the case of a STR device, it may be possible that the non-AP wireless device includes multiple radios capable of performing a full range of uplink and downlink communications, such that uplink data can be transmitted on one link while downlink data is received on another link, at least in some embodiments.

The AP wireless device may initiate a first data transmission to a non-AP wireless device with which it has formed an association (554), on a first wireless link of the association. At least according to some embodiments, initiating the first data transmission may include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs). The non-AP wireless device may receive the downlink transmission on the first wireless link.

The non-AP wireless device may determine to preempt the downlink transmission (556). The determination may be based on arrival of low latency uplink data at a baseband layer of the non-AP wireless device (e.g., which may be a higher priority than the downlink transmission), as one possibility. For example, uplink data may have a delay bound which is less than the indicated duration of the downlink transmission, such that the QoS requirements for the uplink data may not be met if the non-AP wireless device were to wait to transmit the uplink data until after the downlink transmission were completed. In this scenario, if the non-AP wireless device is an eMLSR device that cannot both receive the downlink transmission on the first wireless link and transmit the uplink data on a second wireless link simultaneously, the non-AP wireless device may determine to preempt the first data transmission in order to possibly be able to transmit the uplink data within its delay bound.

In another scenario that could occur, a STR capable non-AP wireless device may determine to preempt the first data transmission due to differing link characteristics between the first wireless link and the second wireless link. For example, in some scenarios, a 2.4 GHz link may be more likely to experience interference or otherwise have a lower data capacity or higher latency expectation than a 5 GHz link or a 6 GHz link. In this case, even if the non-AP wireless device is capable of transmitting uplink data on the second wireless link while receiving the first data transmission on the first wireless link, the non-AP wireless device may determine to preempt the first data transmission, e.g., in order to potentially use the first wireless link for the higher priority uplink data.

As a still further possible scenario, the non-AP wireless device may have a co-existence event scheduled (e.g., for Wi-Fi based peer-to-peer communication with another wireless device, for Bluetooth based communication, or for any of various other possible types of coexistence events), and may determine to preempt the first data transmission in order to perform the coexistence event. Note that other reasons are also possible in addition or as alternatives to these various possible reasons for determining to preempt the first data transmission on the first wireless link.

The non-AP wireless device may provide preemption signaling for the first data transmission to the AP wireless device on a second wireless link (558). The preemption signaling may take any of a variety of possible forms, possibly depending on the type of scenario for which the preemption signaling is being provided. In some instances, the preemption signaling may include reason or cause information for the preemption signaling, for example to indicate whether the preemption is for low latency uplink data, coexistence engagement, etc.

As one possibility, the preemption signaling may include an explicit preemption indication frame. In such a scenario, the preemption indication frame may indicate that the non-AP wireless device has terminated reception of the downlink transmission. The preemption indication frame may have a frame format that is defined in IEEE 802.11 specifications, at least in some embodiments. Alternatively, or in addition, the frame format used may depend at least in part on AP implementation, and/or configuration/agreement between the AP wireless device and the non-AP wireless device, for example as part of establishing the wireless association. The frame format may include fields for indicating any or all of a wireless link identifier for the wireless link that is being preempted (e.g., indicating that the first wireless link is being preempted), a power management bit for the wireless link that is being preempted, a starting sequence number of a packet that is being preempted, a traffic identifier (TID) value of the packet that is being preempted, or whether retry of the packet that is being preempted is requested. Other fields are also possible.

As another possibility, the preemption signaling may include an implicit preemption indication frame. In such a scenario, a frame transmitted by the non-AP wireless device and received by the AP wireless device on the second wireless link of an eMLSR link pair may be interpreted by the AP wireless device (e.g., based on certain characteristics or circumstances under which the frame is communicated) as an implicit indication that the non-AP wireless device has terminated reception of the downlink transmission on the first wireless link. The frame itself could be a control signaling frame such as a request-to-send (RTS) frame (such as a multi-user RTS or MU-RTS), a clear-to-send (CTS)-to-self frame, or any of various other types of frames. It may be the case that the circumstances under which a frame is interpreted as such an implicit preemption indication are described in IEEE 802.11 specifications, according to some embodiments. Alternatively, or in addition, such circumstances may be subject to AP implementation, and/or configured/agreed between the AP wireless device and the non-AP wireless device, for example as part of establishing the wireless association. One such possible set of circumstances may include the non-AP being an eMLSR device that is transmitting any frame on a second wireless link during a downlink transmission on a first wireless link. For example, since such a device may not be able to simultaneously transmit and receive on multiple links, an uplink transmission on the second wireless link during a downlink transmission on the first wireless link may require that the non-AP wireless device has abandoned the downlink transmission in order to be able to perform the uplink transmission, at least in some instances.

As a still further possibility, the preemption signaling may include an explicit preemption request frame. In such a scenario, the preemption request frame may indicate that the non-AP wireless device has not yet terminated reception of the downlink transmission, but is requesting that the downlink transmission be preempted. The preemption request frame may have a frame format that is defined in IEEE 802.11 specifications, at least in some embodiments. Alternatively, or in addition, the frame format used may depend at least in part on AP implementation, and/or configuration/agreement between the AP wireless device and the non-AP wireless device, for example as part of establishing the wireless association. The frame format may include fields for indicating any or all of a wireless link identifier for the wireless link that is being preempted (e.g., indicating that the first wireless link is being preempted), a power management bit for the wireless link that is being preempted, a starting sequence number of a packet that is being preempted, a traffic identifier (TID) value of the packet that is being preempted, or whether retry of the packet that is being preempted is requested. The frame format may additionally or alternatively include fields for indicating any or all of a request to send a trigger frame on the first wireless link, a tolerable delay bound of uplink traffic for which preemption of the downlink transmission is requested, or a queue size of the uplink traffic for which preemption of the downlink transmission is requested. Other fields are also possible. For example, an STR capable wireless device may use such frame format to transmit uplink data on the first wireless link rather than the second wireless link. As another possibility, such a frame format may be used by an eMLSR capable wireless device with limited simultaneous transmit capability, which may for example be able to transmit the preemption request using an auxiliary radio on the second wireless link while continuing to use a main radio to receive the first data transmission on the first wireless link.

In some embodiments, the non-AP wireless device may transmit additional control signaling in conjunction with the preemption signaling. For example, the non-AP wireless device may transmit an initial control frame (ICF), such as a RTS or a CTS-to-self frame, after performing medium contention on the second wireless link, before sending the preemption signaling. Alternatively, as previously noted, such control signaling may itself function as the preemption signaling, e.g., as an implicit preemption indication, at least in some circumstances. The control signaling and/or preemption signaling may be transmitted by any of various possible combinations of a main radio or an auxiliary radio of the non-AP wireless device, according to various embodiments and possibly depending on the multi-link capability of the non-AP wireless device (e.g., eMLSR vs. STR, etc.). At least in the case of use of a RTS frame by the non-AP wireless device, the AP wireless device may respond with a CTS frame.

In some embodiments, it may be possible that the non-AP wireless device transmits the ICF (e.g., MU-RTS) with additional padding to provide sufficient time for switching the main radio of the non-AP wireless device from the first wireless link to the second wireless link. In such a scenario, the preemption signaling may be transmitted from the non-AP wireless device to the AP wireless device using the main radio of the non-AP wireless device after the CTS frame is received from the AP wireless device, at least as one possibility.

In some embodiments, the non-AP wireless device may also provide block acknowledgement (BA) information (e.g., a BA frame) for the first data transmission, for example to indicate which portion of the first data transmission was received by the non-AP wireless device before its preemption. Such information may be provided as a separate frame from the frame(s) providing the preemption signaling (e.g., possibly after the uplink data transmission for which the preemption is performed), or may be provided together (e.g., integrated into one aggregated MPDU transmission), according to various embodiments. As a further possibility, the BA frame itself may include preemption indication information.

After providing the preemption signaling, the non-AP wireless device may perform an uplink transmission or coexistence communication or otherwise follow up on the reason for providing the preemption signaling. In case of performing an uplink transmission, the uplink transmission may be performed on the second wireless link (e.g., as a continuation of the medium usage obtained to provide the preemption signaling), as one possibility. As another possibility, the uplink transmission may be performed on the first wireless link. This may occur if the preemption signaling requests the preemption of the first downlink data transmission in order to perform an uplink transmission on the first wireless link, in some embodiments. In this case, the AP wireless device may provide a trigger frame to the non-AP wireless device on the first wireless link to trigger the uplink transmission, and the non-AP wireless device may perform the uplink transmission to the AP wireless device on the first wireless link in response to the trigger frame.

It may be the case that when the first data transmission is preempted, the AP wireless device determines to not reduce the downlink transmission rate for the non-AP wireless device. For example, in view of the preemption signaling, the AP wireless device may be aware that any missed packets of the first data transmission are not due to poor channel conditions, such that a reduction of the downlink transmission rate for the non-AP wireless device may not be beneficial.

Note that while many of the embodiments described herein may include a (“first”) non-AP wireless device that is the recipient of a downlink transmission on a first link preempting the downlink transmission, it may also be possible that such a downlink transmission can be preempted by another (“second”) non-AP wireless device, according to various embodiments. For example, it may be possible that the second non-AP wireless device can detect that the first wireless link is occupied by the first downlink data transmission from the AP wireless device to the first non-AP wireless device, and determine to preempt the first downlink data transmission, for example due to arrival at baseband of high priority uplink data. In such a scenario, the second non-AP wireless device may be able to provide preemption signaling on the second wireless link requesting or indicating preemption of the downlink transmission on the first wireless link, which the AP wireless device may choose how to respond to.

Thus, according to the method of FIG. 5, it may be possible to preempt downlink transmissions in a WLAN setting, for example to provide better handling for low latency uplink traffic and/or co-existence events, among various possibilities. Such techniques may provide improved latency for targeted traffic types, reduced need for error handling, reduced coexistence interference caused, and/or provide any of a variety of other possible benefits, at least according to some embodiments.

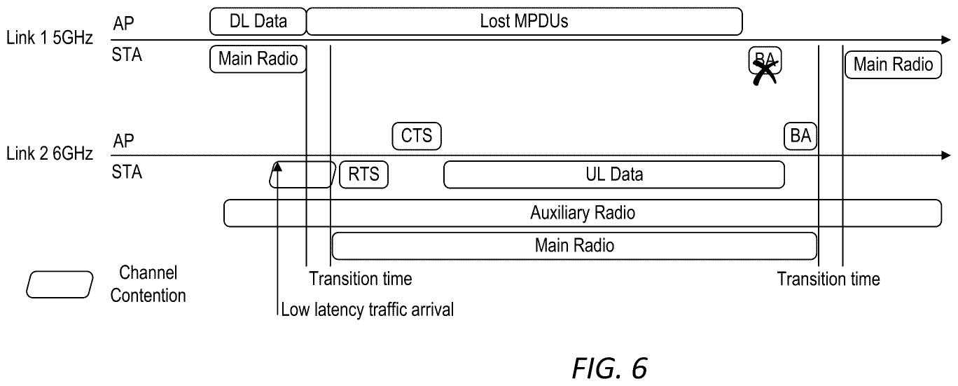

### FIGS. 6-20 and Additional Information

FIGS. 6-20 illustrate further aspects that might be used in conjunction with the method of FIG. 5 if desired. It should be noted, however, that the example details illustrated in and described with respect to FIGS. 6-20 are not intended to be limiting to the disclosure as a whole: numerous variations and alternatives to the details provided herein below are possible and should be considered within the scope of the disclosure.

In a Wi-Fi based wireless communication system, scenarios could occur in which a station (STA) has low latency traffic to transmit to an access point (AP) or in which a coexistence event is scheduled while it is engaged with the AP in receiving downlink (DL) data. Typically, a STA may wait for the AP to complete the DL transmission to inform the AP of latency sensitive data or contend for channel access. In some embodiments, however, it may be possible for a STA (e.g., in enhanced multi-link single radio (eMLSR) or simultaneous transmit and receive (STR) mode) to preempt the DL data and transmit low latency uplink (UL) data or observe a coexistence event. For example, an eMLSR STA may be able to preempt a downlink transmission on one link when it can access a second link, including informing the AP on the second link that it is no longer listening to the first link. This may allow the AP to cancel the DL transmission on the first link and trigger the UL data transmission; the STA may also or alternatively be able to use the second link to send the low latency data if suitable, and potentially inform the AP of its unavailability on the first link.

In some instances, it may be possible for a STA to effectively preempt a DL transmission on one link to perform a low latency UL transmission on another link without explicitly informing the AP. FIG. 6 illustrates example aspects of one such possible scenario, according to some embodiments. In the illustrated scenario, an AP multi-link device (MLD) (or simply ‘AP’) may be wirelessly connected to a non-AP MLD eMLSR (or simply ‘STA’) on two links (e.g., 5 GHz and 6 GHz). The ‘main’ radio of the STA may be receiving DL data from the AP on ‘link l’. When low latency UL data arrives, the ‘auxiliary’ radio may contend for channel access on the other link (‘link 2’). The STA can preempt the DL traffic as follows. The main radio may switch to link 2 when the backoff counter is about to expire (e.g., abandoning the DL traffic). The main radio may begin using link 2 for UL traffic. The AP may continue the DL transmission and may not receive a block acknowledgment (BA) after finishing the physical layer protocol data unit (PPDU), e.g., since the STA may have abandoned the DL transmission. This approach may have several drawbacks. The channel may be busy after switching the main radio from link 1 to link 2 and channel access may not be guaranteed. This approach may also make inefficient use of the medium, and can cause the AP to drop the DL rate for the STA, e.g., due to not receiving the BA for the DL data. It may also cause confusion or otherwise present problems for an AP implementation where a STA is assumed to be eMLSR, yet appears to be engaged in transmission and reception simultaneously from the AP point of view.

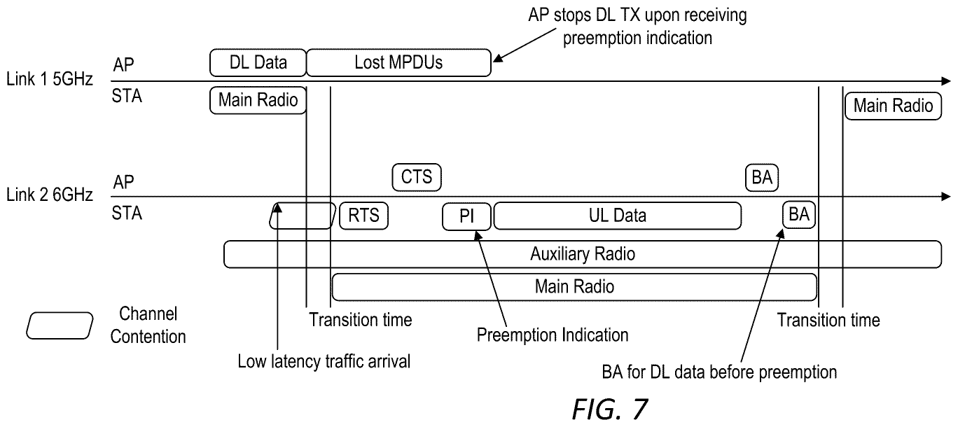

FIG. 7 illustrates example aspects of an alternative scenario of UL preemption of DL data, according to some embodiments. In the illustrated scenario, as in FIG. 6, an AP MLD (or simply ‘AP’) may be wirelessly connected to a non-AP MLD eMLSR (or simply ‘STA’) on two links (e.g., 5 GHz and 6 GHz). The main radio of the STA may be receiving DL data from the AP on link 1. When low latency UL data arrives, the auxiliary radio may contend for channel access on link 2. The STA can preempt the DL traffic as follows. The main radio may switch to link 2 when the backoff counter is about to expire (e.g., abandoning the DL traffic). The main radio may send a preemption indication (explicit or implicit) to the AP to indicate preemption of DL data; use of request-to-send (RTS) and clear-to-send (CTS) signaling may be optional. An explicit preemption frame may be a frame transmitted to the AP to inform the AP that the STA is no longer receiving the data on one or more links. An implicit preemption may occur if a rule is configured (e.g., as part of network configuration, or in IEEE 802.11 specifications, among various possibilities) to indicate when the AP considers a DL frame to be preempted by the receiving STA and not lost. Such a rule may be configured, for example, for a scenario in which an AP starts a DL frame exchange with an eMLSR STA using RTS and CTS or other initial control frames, then starts receiving an UL frame from the same STA on a different link that belongs to the same eMLSR pair. The AP, upon receiving the (explicit or implicit) preemption indication, may stop the DL transmission, and may terminate the transmit opportunity (TXOP) or reuse the time for other STAs. The AP may choose to not drop the rate of DL transmission for the STA, since the AP may know that the STA was unavailable (e.g., rather than experiencing data loss due to poor channel conditions, as one possibility). As shown, the non-AP eMLSR STA may also provide a BA for the received frames from the preempted DL data on link 1, e.g., to indicate any media access control (MAC) protocol data units (MPDUs) received before the preemption, potentially with or without BA request (BAR) from the AP. Note that while this approach may make more efficient use of the medium and reduce the likelihood of causing confusion to the AP relative to the approach of FIG. 6, it may still be possible that the channel could be busy after main radio switching such that channel access may not be guaranteed.

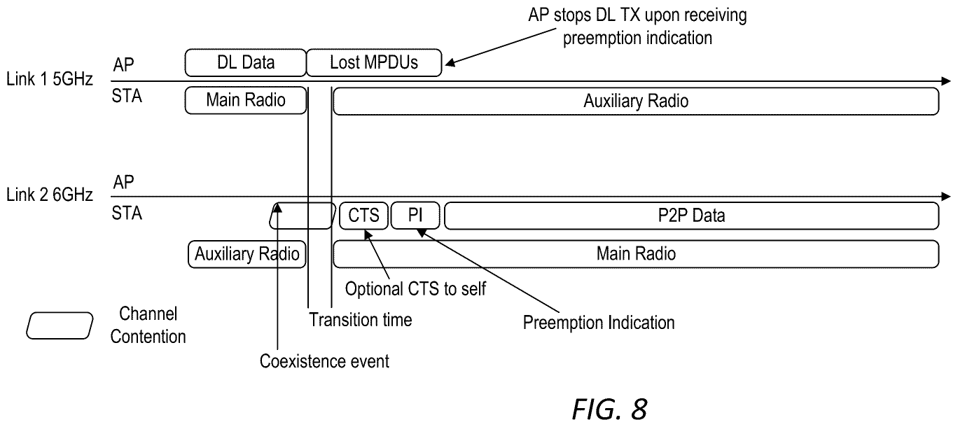

FIGS. 8-9 illustrate example aspects of possible scenarios in which preemption signaling can be used to preempt DL data for coexistence operation, according to some embodiments. In the illustrated scenarios, as in FIGS. 6-7, an AP MLD (or simply ‘AP’) may be wirelessly connected to a non-AP MLD eMLSR (or simply ‘STA’) on two links (e.g., 5 GHz and 6 GHz). The main radio of the STA may be receiving DL data from the AP on link 1. If a coexistence event is due (e.g., a Bluetooth or peer-to-peer (P2P) coexistence event, as some possibilities), the auxiliary radio can contend for channel access on the other link. The STA can preempt the DL traffic as follows. The main radio may switch to link 2 when the backoff counter is about to expire (e.g., abandoning the DL traffic). The main radio may send an optional CTS to protect the medium. The main radio may send a preemption indication to the AP to indicate preemption of DL data for coexistence reasons. A BA can be sent after the preemption indication (PI) for the DL MPDUs received on link 1 (e.g., as shown in FIG. 9), or both the PI and the BA can be integrated into one aggregated MPDU (AMPDU) transmission. It may also be possible that no BA is provided (e.g., as shown in FIG. 8). Upon receiving the preemption indication, the AP may stop the DL transmission on link 1, and may terminate the TXOP or reuse the time for other STAs. The AP may choose to not drop the rate of DL transmission for the STA, since the AP may know that the STA was unavailable. Similar to the approach of FIG. 7, in the approaches of FIGS. 8-9, it may still be possible that the channel could be busy after main radio switching such that channel access may not be guaranteed.

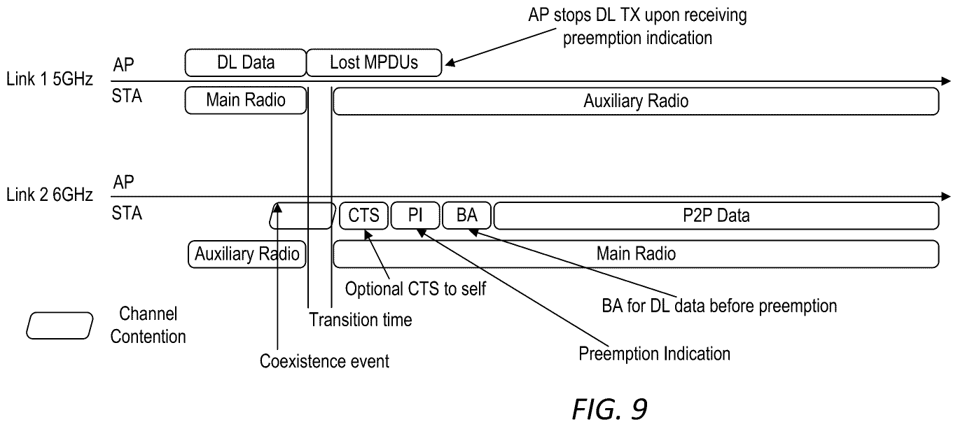

FIGS. 10-11 illustrate example aspects of further possible scenarios in which preemption signaling can be used for UL preemption of DL data, according to some embodiments. In the illustrated scenarios, as in FIGS. 6-9, an AP MLD (or simply ‘AP’) may be wirelessly connected to a non-AP MLD eMLSR (or simply ‘STA’) on two links (e.g., 5 GHz and 6 GHz). In these scenarios, the auxiliary scan radio on the STA may have limited transmit capability (e.g., maximum 20 MHz bandwidth (BW) and modulation and coding scheme (MCS) 4, as one possibility). The main radio of the STA may be receiving DL data from the AP on link 1. When low latency UL data arrives, the auxiliary radio may contend for channel access on link 2. The STA can preempt the DL traffic as follows. The main radio may switch to link 2 when the backoff counter is about to expire (e.g., abandoning the DL traffic).

In the scenario of FIG. 10, the auxiliary radio may transmit an initial control frame (ICF) such as a multi-user RTS (MU-RTS) to the AP on link 2 with padding to cover the time for the main radio to switch from link 1 to link 2. The main radio, once it has stopped listening to the DL data on link 1 and switched to link 2, may receive the CTS frame from the AP and may send a preemption indication (explicit or implicit) to the AP to indicate preemption of DL data after receiving the CTS frame. Upon receiving the preemption indication, the AP may stop the DL transmission, and may terminate the TXOP or reuse the time for other STAs. The AP may choose to not drop the rate of DL transmission for the STA, since the AP may know that the STA was unavailable. A BA can be sent to indicate the MPDU(s) received before preemption, with or without BAR, after the low latency data transmission and acknowledgement.

In the scenario of FIG. 11, the STA may be able to eliminate the padding delay of the scenario of FIG. 10 that is used to allow the main radio to switch to the link where the low latency traffic will be transmitted. In this case, the auxiliary radio can send the RTS frame and wait to receive the CTS frame. During the time of transmitting the RTS frame and receiving the CTS frame (e.g., RTS+short interframe space (SIFS)+CTS+SIFS), the main radio may be able to switch from link 1 to link 2. This may allow the main radio, having switched to link 2, to transmit the preemption indication a SIFS after receiving the CTS from the AP. The main radio may transmit the low latency data afterwards, in a similar manner as shown in FIG. 10.

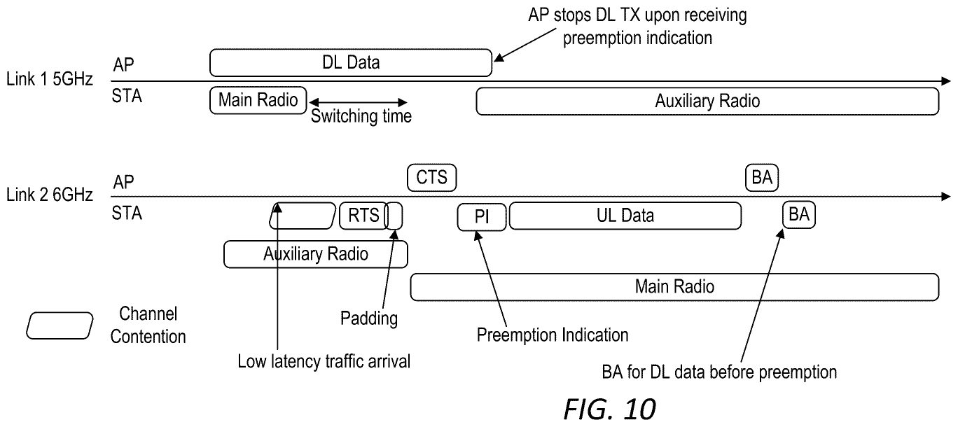

FIG. 12 illustrates example aspects of an AP centric variation of the scenarios of FIGS. 10-11, according to some embodiments. In the illustrated scenario, as in FIGS. 6-11, an AP MLD (or simply ‘AP’) may be wirelessly connected to a non-AP MLD eMLSR (or simply ‘STA’) on two links (e.g., 5 GHz and 6 GHz). In these scenarios, the auxiliary scan radio on the STA may have limited transmit capability (e.g., maximum 20 MHz BW and MCS 4, as one possibility). The main radio of the STA may be receiving DL data from the AP on link 1. When low latency UL data arrives, the auxiliary radio may contend for channel access on link 2. If the auxiliary radio gains access to the channel on link 2 while the main radio of the STA is engaged in DL transmission on link 1, preemption can be performed. The auxiliary radio may send a preemption request to the AP on link 2, and if the AP accepts the preemption request, the AP may stop DL transmission and send a trigger frame to the STA on link 1 for UL transmission. The AP may send a BAR to the STA to solicit a BA for any received DL frames from the preempted DL transmission after the UL transmission.

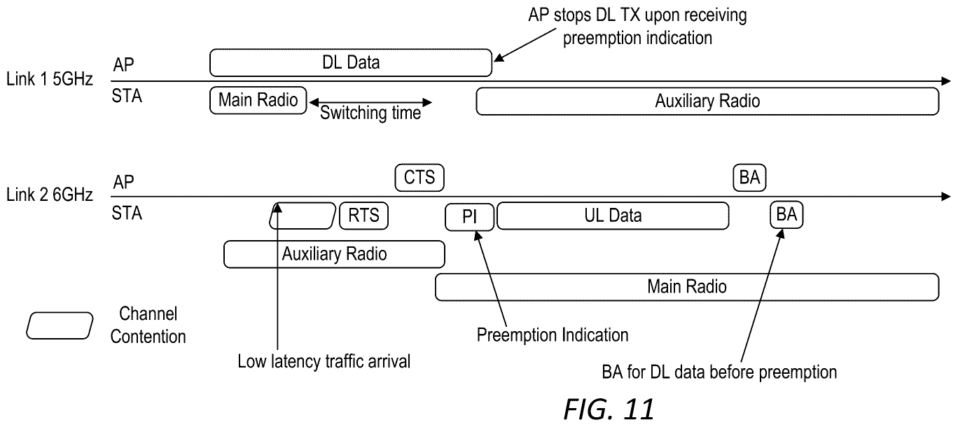

FIG. 13 illustrates example aspects of a further possible scenario in which preemption signaling can be used to preempt DL data for coexistence operation, according to some embodiments. In the illustrated scenario, as in FIGS. 6-12, an AP MLD (or simply ‘AP’) may be wirelessly connected to a non-AP MLD eMLSR (or simply ‘STA’) on two links (e.g., 5 GHz and 6 GHz). In this scenario, the auxiliary scan radio on the STA may have limited transmit capability (e.g., maximum 20 MHz BW and MCS 4, as one possibility). The main radio of the STA may be receiving DL data from the AP on link 1. If a coexistence event is due (e.g., a Bluetooth or P2P coexistence event, as some possibilities), the auxiliary radio can contend for channel access on the other link. The STA can preempt the DL traffic as follows. The main radio may switch to link 2 when the backoff counter expires. It may be the case that the main radio only abandons the DL traffic if the auxiliary radio has successfully obtained channel access. While the main radio transitions from link 1 to link 2, the auxiliary radio may send an optional CTS to protect the medium and a preemption indication to the AP to indicate preemption of DL data for coexistence reasons. When the main radio completes the transition from link 1 to link 2,the main radio may start using link 2 for P2P data (e.g., in the illustrated scenario, or alternatively performing Bluetooth communication or other coexistence communication), and optionally send a BA for any DL MPDUs received on link 1. Upon receiving the preemption indication, the AP may stop the DL transmission on link 1, and may terminate the TXOP or reuse the time for other STAs. The AP may choose to not drop the rate of DL transmission for the STA, since the AP may know that the STA was unavailable.

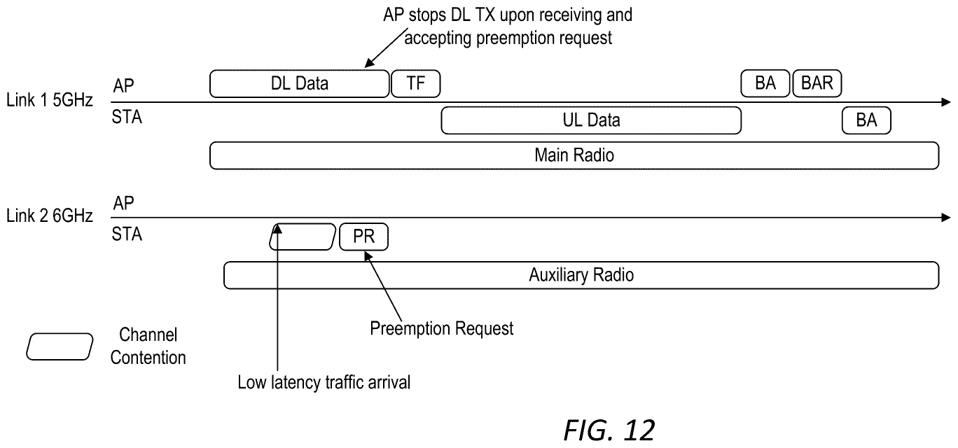

FIGS. 14-15 illustrate example aspects of more possible scenarios in which preemption signaling can be used to preempt DL data for UL data, according to some embodiments. In the illustrated scenarios, an AP MLD (or simply ‘AP’) may be wirelessly connected to a non-AP MLD in simultaneous transmit and receive (STR) mode (or simply ‘STA’) on two links (e.g., 5 or 6 GHz and 2.4 GHz). Such a STA may want to preempt a high BW transmission on one link to enable low latency traffic. The STA may be able to gain channel access on link 2. As shown in FIG. 14, it may be possible for the STA to use link 2 to transmit its UL data, however, it may be the case that this link is slower and/or more BW limited than link 1. Accordingly, as another option, and as shown in FIG. 15, the STA may be able to request to preempt the DL transmission on the faster link 1 to transmit the UL low latency traffic. In this scenario, the STA may send a preemption request on link 2 to the AP. The AP may be able to respond with a preemption response indicating approval or rejection of the request. If rejected, the STA may be able to continue using link 2 for the UL transmission. If accepted, the AP may stop the DL transmission on link 1, and may send a trigger frame to the STA. The STA may perform the UL transmission on link 1. The AP may send a BAR after the UL transmission to solicit BA transmission by the STA for any DL MPDUs received on link 1 before the DL transmission preemption. Note that in some embodiments, it may be possible for the recipient of downlink data to request preemption of that downlink data, or for another STA in the same wireless communication system to request preemption of that downlink data.

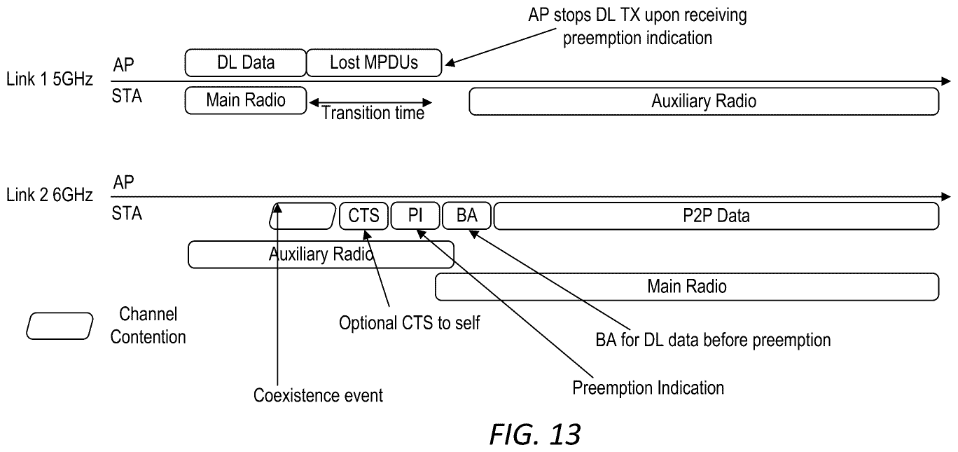

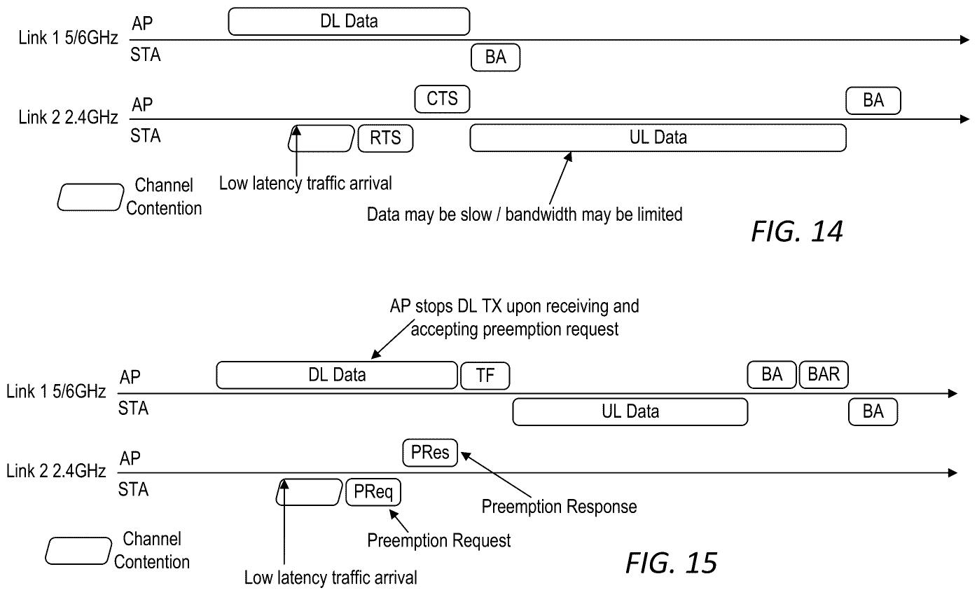

It may be possible for preemption indications, requests, and/or responses to be provided in any of a variety of ways. As one possibility, preemption indication information can be included in an A-Control subfield which is sent in a control frame or data frame. FIG. 16 illustrates an example of a possible set of A-Control subfields that could be used for such a purpose, according to some embodiments. As another possibility, the indication information can be included in a new management or control frame, e.g., that can be aggregated in an A-MPDU. FIG. 17 illustrates an example of such a possible preemption indication frame, including possible preemption indication information subfields, according to some embodiments. In either such case, it may be possible that the information in the preemption indication can include any or all of a link bitmap (e.g., a bitmap to indicate for which link this frame is indicating preemption, which may be 1 or 2 octets, as one possibility), a power management (PM) bit (e.g., for the link over which the packet is preempted, and which may be 1 bit, as one possibility), a starting sequence control (e.g., indicating a starting sequence number of the packet preempted, which may be 2 octets, as one possibility), a TID value (e.g., indicating a value of the TID of the packet preempted, which may be 4 bits, as one possibility), or a retry request (e.g., an indicator to request retry of the whole preempted PPDU if set, or to inform the peer STA to wait for BA or request a BA if not set, which may be 1 bit, as one possibility), among various possibilities.

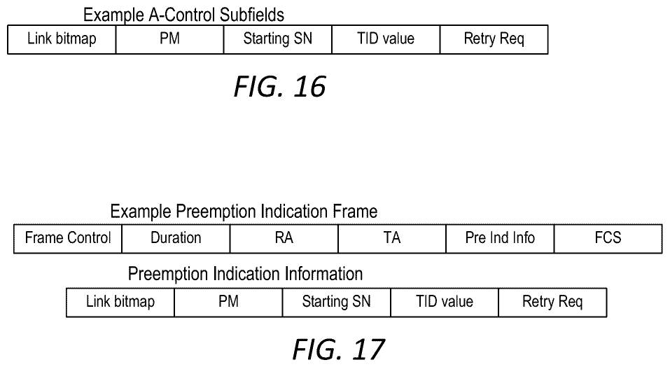

A further possibility can include using a multi-STA (M-STA) block acknowledgement (BA) frame as a preemption indication. The multi-STA BA can carry additional information, e.g., besides BA bitmap to acknowledge A-MPDU(s) and/or MPDU(s); for example, indication information can be provided in a M-STA BA frame to indicate that a preemption happened on a different link. FIG. 18 illustrates an example of a possible BA frame with preemption indication, according to some embodiments. As shown, the BA frame can indicate BA type (11), a multi-STA BA. A new per-AID TID info field can be used to add the preemption indication information. The AID11 field can use a special value configured to indicate that it carries a preemption indication. As another possibility, the AID11 field can use the peer STA AID. The acknowledgment (ACK) type and TID combination can be selected to indicate that the M-STA BA carries a preemption indication. Other fields in the per-AID TID info portion can be used to carry the preemption indication information.

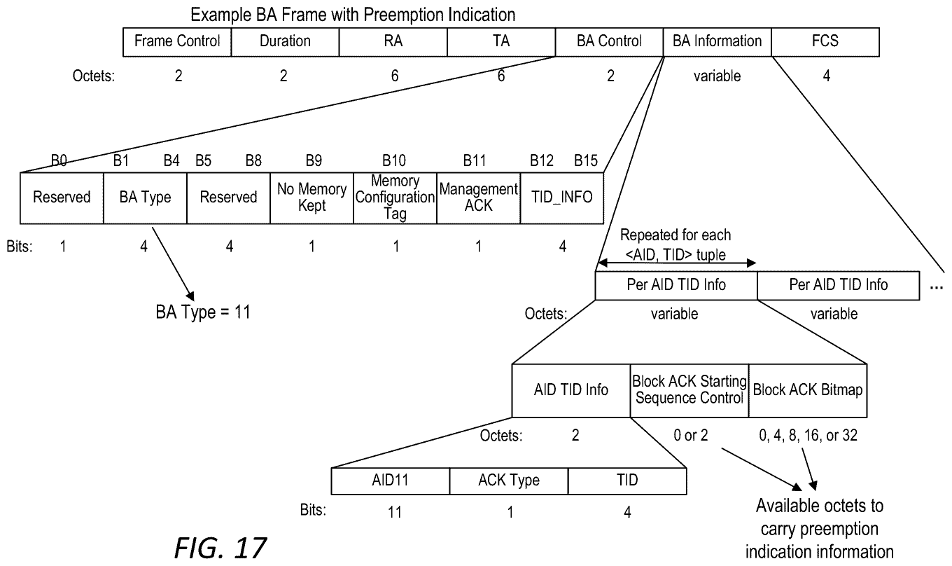

FIG. 19 illustrates an example of a possible preemption request frame, which can be a new management or control frame, e.g., that can be aggregated in an A-MPDU, including possible preemption request information subfields, according to some embodiments. As shown, it may be possible that the information in the preemption request can include any or all of a link bitmap (e.g., a bitmap to indicate for which link this frame is requesting preemption, which may be 1 or 2 octets, as one possibility), a power management (PM) bit (e.g., for the link over which the packet is preempted, and which may be 1 bit, as one possibility), a starting sequence control (e.g., indicating a starting sequence number of the packet preempted, which may be 2 octets, as one possibility), a TID value (e.g., indicating a value of the TID of the packet preempted, which may be 4 bits, as one possibility), a retry request (e.g., an indicator to request retry of the whole preempted PPDU if set, or to inform the peer STA to wait for BA or request a BA if not set, which may be 1 bit, as one possibility), a trigger frame request (e.g., an indicator that the STA is requesting the AP to send a trigger frame, which may be 1 bit, as one possibility), a delay bound (e.g., an indication of the tolerable delay bound of the traffic for which the packet is being preempted, which may be 2 octets, as one possibility), or a queue size (e.g., an indication of the queue size (e.g., in bytes) for the traffic for which the packet is being preempted, which may be 2 octets, as one possibility), among various possibilities.

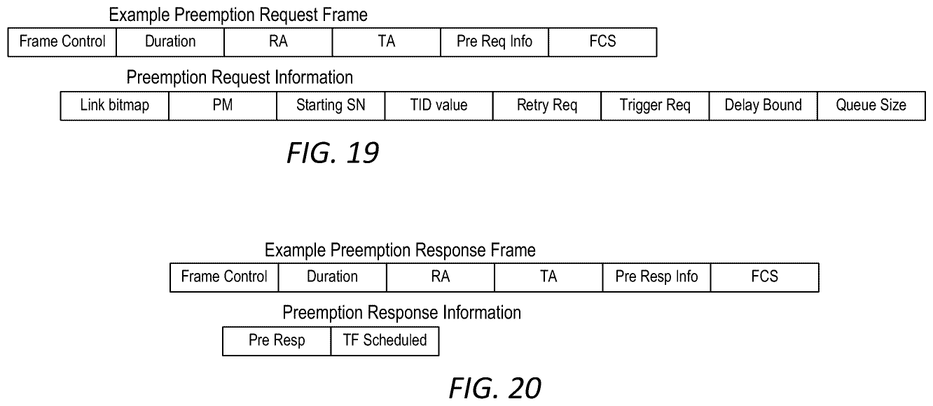

FIG. 20 illustrates an example of a possible preemption response frame, which can be a new management or control frame, e.g., that can be aggregated in an A-MPDU, including possible preemption response information subfields, according to some embodiments. As shown, it may be possible that the information in the preemption response can include any or all of a preemption response field (e.g., an indication of acceptance or rejection of the preemption request, which may be 1 bit, as one possibility) or a trigger frame scheduled field (e.g., an indication of whether a trigger frame will be scheduled according to the delay bound and queue size on the preempted link, which may be 1 bit, as one possibility), among various possibilities.

In the following further example embodiments are provided.

One set of embodiments may include a method, comprising: by a non-access point (AP) wireless device: receiving a downlink transmission from an AP wireless device on a first wireless link; and transmitting preemption signaling to the AP wireless device on a second wireless link, wherein the preemption signaling indicates to preempt the downlink transmission on the first wireless link.

According to some embodiments, the non-AP wireless device is an enhanced multi-link single radio (eMLSR) wireless device, wherein the preemption signaling comprises any signaling from the non-AP wireless device on the second wireless link during the downlink transmission on the first wireless link.

According to some embodiments, the preemption signaling comprises fields indicating one or more of: a wireless link identifier for a wireless link that is being preempted; a power management bit for the wireless link that is being preempted; a starting sequence number of a packet that is being preempted; a traffic identifier (TID) value of the packet that is being preempted; or whether retry of the packet that is being preempted is requested.

According to some embodiments, the preemption signaling further comprises fields indicating one or more of: a request to send a trigger frame on the first wireless link; a tolerable delay bound of uplink traffic for which preemption of the downlink transmission is requested; a queue size of the uplink traffic for which preemption of the downlink transmission is requested.

According to some embodiments, the method further comprises: transmitting a request-to-send frame to the AP wireless device on the second wireless link using an auxiliary radio of the non-AP wireless device, wherein the request-to-send frame includes an amount of padding selected to provide sufficient time to switch a main radio of the non-AP wireless device from the first wireless link to the second wireless link; and receiving a clear-to-send frame from the AP wireless device on the second wireless link in response to the request-to-send frame, wherein the clear-to-send frame is received using the main radio of the non-AP wireless device, wherein the preemption signaling is transmitted to the AP wireless device using the main radio of the non-AP wireless device after the clear-to-send frame is received from the AP wireless device.

According to some embodiments, the preemption signaling is transmitted based at least in part on arrival of low latency uplink data at a baseband layer of the first wireless device.

According to some embodiments, the preemption signaling is transmitted based at least in part on a coexistence event for the first wireless device.

Another set of embodiments may include an apparatus, comprising: a processor configured to cause a first wireless device to: determine that a first wireless link is occupied by a downlink transmission from a second wireless device; and transmit preemption signaling to the second wireless device on a second wireless link, wherein the preemption signaling is associated with the downlink transmission occupying the first wireless link.

According to some embodiments, the preemption signaling is transmitted based at least in part on arrival of low latency uplink data at a baseband layer of the first wireless device, wherein the processor is further configured to cause the wireless device to: transmit the low latency uplink data to the second wireless device after the preemption signaling is transmitted.

According to some embodiments, the preemption signaling is transmitted based at least in part on a coexistence event for the first wireless device, wherein the processor is further configured to cause the wireless device to: perform coexistence communication with a third wireless device during the coexistence event.

According to some embodiments, the preemption signaling comprises one or more of: a frame configured to implicitly indicate that the first wireless device has terminated reception of the downlink transmission based on the first wireless device being an enhanced multi-link single radio (eMLSR) wireless device that is transmitting on the second wireless link during the downlink transmission on the first link; a preemption indication frame configured to explicitly indicate that the first wireless device has terminated reception of the downlink transmission; or a preemption request frame configured to explicitly request termination of the downlink transmission.

According to some embodiments, the first wireless device is a recipient of the downlink transmission.

According to some embodiments, a third wireless device is a recipient of the downlink transmission.

Yet another set of embodiments may include an access point (AP) wireless device, comprising: one or more antennas; a radio operably coupled to the one or more antennas; and a processor operably coupled to the radio; wherein the AP wireless device is configured to: transmit a downlink transmission to a non-AP wireless device on a first wireless link; receive signaling from the non-AP wireless device on a second wireless link during the downlink transmission; and preempt the downlink transmission based at least in part on the signaling from the non-AP wireless device on the second wireless link.

According to some embodiments, the non-AP wireless device is an enhanced multi-link single radio (eMLSR) wireless device, wherein the AP wireless device is further configured to: determine that the signaling from the non-AP wireless device on the second wireless link is an implicit preemption indication for the downlink transmission based at least in part on the signaling being received during the downlink transmission on a different wireless link than the downlink transmission and the signaling being received from an eMLSR wireless device.

According to some embodiments, the signaling received from the non-AP wireless device on the second wireless link during the downlink transmission comprises a preemption indication frame explicitly indicating that the non-AP wireless device has terminated reception of the downlink transmission.

According to some embodiments, the signaling received from the non-AP wireless device on the second wireless link during the downlink transmission comprises a preemption request frame explicitly requesting preemption of the downlink transmission.

According to some embodiments, the AP wireless device is further configured to: determine to not reduce a downlink transmission rate for the non-AP wireless device based at least in part on the signaling from the non-AP wireless device on the second wireless link during the downlink transmission.

According to some embodiments, the AP wireless device is further configured to: receive an uplink transmission from the non-AP wireless device; and receive a block acknowledgement for the downlink transmission from the non-AP wireless device after the uplink transmission is received from the non-AP wireless device.

According to some embodiments, the AP wireless device is further configured to: transmit a trigger frame to the non-AP wireless device to trigger an uplink transmission based at least in part on the signaling received from the non-AP wireless device on the second wireless link during the downlink transmission; and receive an uplink transmission from the non-AP wireless device in response to the trigger frame.

A further example embodiment may include a method, comprising: performing, by a wireless device, any or all parts of the preceding examples.

Another example embodiment may include a device, comprising: an antenna; a radio coupled to the antenna; and a processing element operably coupled to the radio, wherein the device is configured to implement any or all parts of the preceding examples.

A further example set of embodiments may include a non-transitory computer accessible memory medium comprising program instructions which, when executed at a device, cause the device to implement any or all parts of any of the preceding examples.

A still further example set of embodiments may include a computer program comprising instructions for performing any or all parts of any of the preceding examples.

Yet another example set of embodiments may include an apparatus comprising means for performing any or all of the elements of any of the preceding examples.

Still another example set of embodiments may include an apparatus comprising a processor configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described example embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a non-access point (AP) wireless device:
receiving a downlink transmission from an AP wireless device on a first wireless link; and
transmitting preemption signaling to the AP wireless device on a second wireless link, wherein the preemption signaling indicates to preempt the downlink transmission on the first wireless link.

2. The method of claim 1,
wherein the non-AP wireless device is an enhanced multi-link single radio (eMLSR) wireless device, wherein the preemption signaling comprises any signaling from the non-AP wireless device on the second wireless link during the downlink transmission on the first wireless link.

3. The method of claim 1, wherein the method further comprises:
transmitting a request-to-send frame to the AP wireless device on the second wireless link using an auxiliary radio of the non-AP wireless device, wherein the request-to-send frame includes an amount of padding selected to provide sufficient time to switch a main radio of the non-AP wireless device from the first wireless link to the second wireless link; and
receiving a clear-to-send frame from the AP wireless device on the second wireless link in response to the request-to-send frame, wherein the clear-to-send frame is received using the main radio of the non-AP wireless device,
wherein the preemption signaling is transmitted to the AP wireless device using the main radio of the non-AP wireless device after the clear-to-send frame is received from the AP wireless device.

4. The method of claim 1,
wherein the preemption signaling is transmitted based at least in part on arrival of low latency uplink data at a baseband layer of the first wireless device, wherein the method further comprises:
transmitting the low latency uplink data to the AP wireless device after the preemption signaling is transmitted.

5. The method of claim 1,
wherein the preemption signaling is transmitted based at least in part on a coexistence event for the first wireless device, wherein the method further comprises
performing coexistence communication with another wireless device during the coexistence event.

6. The method of claim 1,
wherein the non-AP wireless device is a recipient of the downlink transmission.

7. The method of claim 1,
wherein another non-AP wireless device is a recipient of the downlink transmission.

8. An apparatus comprising processing circuitry and memory, the memory configured to cause the processing circuitry to:
determine that a first wireless link is occupied by a downlink transmission from a wireless device; and
generate preemption signaling for transmission to the wireless device on a second wireless link, wherein the preemption signaling is associated with the downlink transmission occupying the first wireless link.

9. The apparatus of claim 8,
wherein the preemption signaling is generated based at least in part on arrival, at the processor, of low latency uplink data.

10. The apparatus of claim 8,
wherein the preemption signaling is generated based at least in part on a coexistence event.

11. The apparatus of claim 8, wherein the preemption signaling comprises one or more of:
a frame configured to implicitly indicate that reception of the downlink transmission is terminated by being transmitted on the second wireless link by an enhanced multi-link single radio (eMLSR) wireless device during the downlink transmission on the first link;
a preemption indication frame configured to explicitly indicate that reception of the downlink transmission is terminated; or
a preemption request frame configured to explicitly request termination of the downlink transmission.

12. The apparatus of claim 8, wherein the preemption signaling comprises fields indicating one or more of:
a wireless link identifier for a wireless link that is being preempted;
a power management bit for the wireless link that is being preempted;
a starting sequence number of a packet that is being preempted;
a traffic identifier (TID) value of the packet that is being preempted; or
whether retry of the packet that is being preempted is requested.

13. The apparatus of claim 12, wherein the preemption signaling further comprises fields indicating one or more of:
a request to send a trigger frame on the first wireless link;
a tolerable delay bound of uplink traffic for which preemption of the downlink transmission is requested;
a queue size of the uplink traffic for which preemption of the downlink transmission is requested.

14. An access point (AP) wireless device, comprising:
one or more antennas;
a radio operably coupled to the one or more antennas; and
a processor operably coupled to the radio;
wherein the AP wireless device is configured to:
transmit a downlink transmission to a non-AP wireless device on a first wireless link;
receive signaling from the non-AP wireless device on a second wireless link during the downlink transmission; and
preempt the downlink transmission based at least in part on the signaling from the non-AP wireless device on the second wireless link.

15. The AP wireless device of claim 14,
wherein the non-AP wireless device is an enhanced multi-link single radio (eMLSR) wireless device, wherein the AP wireless device is further configured to:
determine that the signaling from the non-AP wireless device on the second wireless link is an implicit preemption indication for the downlink transmission based at least in part on the signaling being received during the downlink transmission on a different wireless link than the downlink transmission and the signaling being received from an eMLSR wireless device.

16. The AP wireless device of claim 14,
wherein the signaling received from the non-AP wireless device on the second wireless link during the downlink transmission comprises a preemption indication frame explicitly indicating that the non-AP wireless device has terminated reception of the downlink transmission.

17. The AP wireless device of claim 14,
wherein the signaling received from the non-AP wireless device on the second wireless link during the downlink transmission comprises a preemption request frame explicitly requesting preemption of the downlink transmission.

18. The AP wireless device of claim 14, wherein the AP wireless device is further configured to:
determine to not reduce a downlink transmission rate for the non-AP wireless device based at least in part on the signaling from the non-AP wireless device on the second wireless link during the downlink transmission.

19. The AP wireless device of claim 14, wherein the AP wireless device is further configured to:
receive an uplink transmission from the non-AP wireless device; and
receive a block acknowledgement for the downlink transmission from the non-AP wireless device after the uplink transmission is received from the non-AP wireless device.

20. The AP wireless device of claim 14, wherein the AP wireless device is further configured to:
transmit a trigger frame to the non-AP wireless device to trigger an uplink transmission based at least in part on the signaling received from the non-AP wireless device on the second wireless link during the downlink transmission; and
receive an uplink transmission from the non-AP wireless device in response to the trigger frame.
